(19) United States
(12) Patent Application Publication
(10) Pub. No.: US 2012/0048167 A1
(43) Pub. Date: Mar. 1, 2012

(54) MOORING DEVICE FOR BOATS

(76) Inventor: Enrico Teruzzi, Basiglio (Milano) (IT)

(21) Appl. No.: 13/319,259

(22) PCT Filed: May 12, 2010
(86) PCT No.: PCT/EP10/02924

§ 371 Date: Nov. 7, 2011

(30) Foreign Application Priority Data
May 13, 2009 (IT) M12009UOOO156

(51) Int. Cl. B63B 21/54; F16B 45/04

(52) U.S. Cl. 114/221 R

(57) ABSTRACT

A mooring device for boats has a first rod having a hook-shaped end adapted to hook a mooring ring, a fastening ring provided at the opposite end with respect to the hook-shaped end, a sliding member adapted to slide along said first rod between at least two positions, a closed position where the sliding member closes said hook-shaped end, and an open position where the sliding member is away from the hook-shaped end. The sliding member is remotely operated by means of a handle sliding on the first rod and associated with said sliding member by means of a second rod.

The present invention relates to a mooring device for mooring boats by fastening to a mooring ring.

In order to moor boats it is necessary to use a rope which is fastened to the boat at one end while the other end is fastened to a device for fastening to a mooring ring.

Since the mooring ring is usually located at a substantial distance with respect to the boat edge, in order to fasten the rope or line to the mooring ring of the buoy or of the wharf or of the quay etcetera, it is necessary to use a device constituted by a rod which in the nautical jargon is known as boat-hook.

The loose end of the rope is positioned and fastened to the mooring ring with the aid of the boat-hook, while leaning out of the boat.

Once the manoeuver for fastening the rope to the mooring ring has been performed, the boat-hook is removed and the boat remains moored.

To unmoor the boat it is necessary to perform a similar procedure. By using the boat-hook, the rope is disengaged from the mooring ring and the boat is thus free to leave.

Both the mooring manoeuver and the unmooring manoeuver can be difficult and may also be dangerous, especially in case of adverse weather conditions and rough sea.

The aim of the present invention is to provide a mooring device, which makes the mooring manoeuver easier, faster and safer.

Within the above aim, an object of the invention is to provide an economical, practical and functional device.

The above aims and other aims that will be more apparent hereinafter, are achieved by a mooring device for boats, characterized in that it comprises a first rod having a hook-shaped end adapted to hook a mooring ring, a fastening ring provided at the opposite end with respect to said hook-shaped end, a sliding member adapted to slide along said first rod between at least two positions, a closed position where said sliding member closes said hook-shaped end, and an open position where said sliding member is away from said hook-shaped end; said sliding member is remotely operated by means of a handle sliding on said first rod and associated with said sliding member by means of a second rod.

Further characteristics and advantages of the invention will be more apparent by the following description of an embodiment of the invention, illustrated, by way of example in the enclosed drawings in which

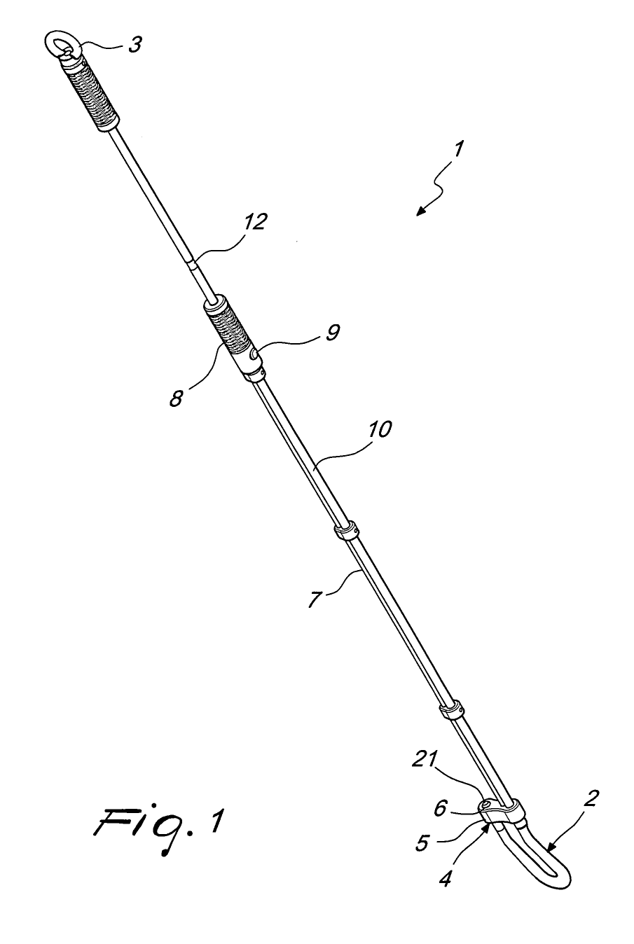

FIG. 1 is a perspective view of the device in the closed configuration;

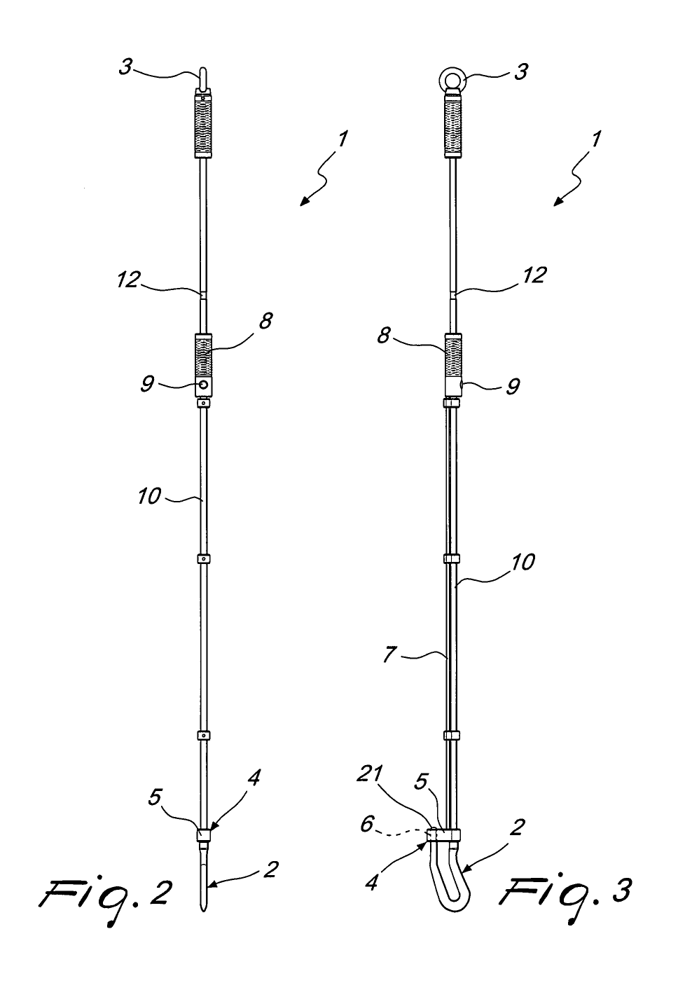

FIG. 2 is a front view of the device in the closed configuration;

FIG. 3 is a side view of the device in the closed configuration;

FIG. 4 is a side view of the device in the open configuration;

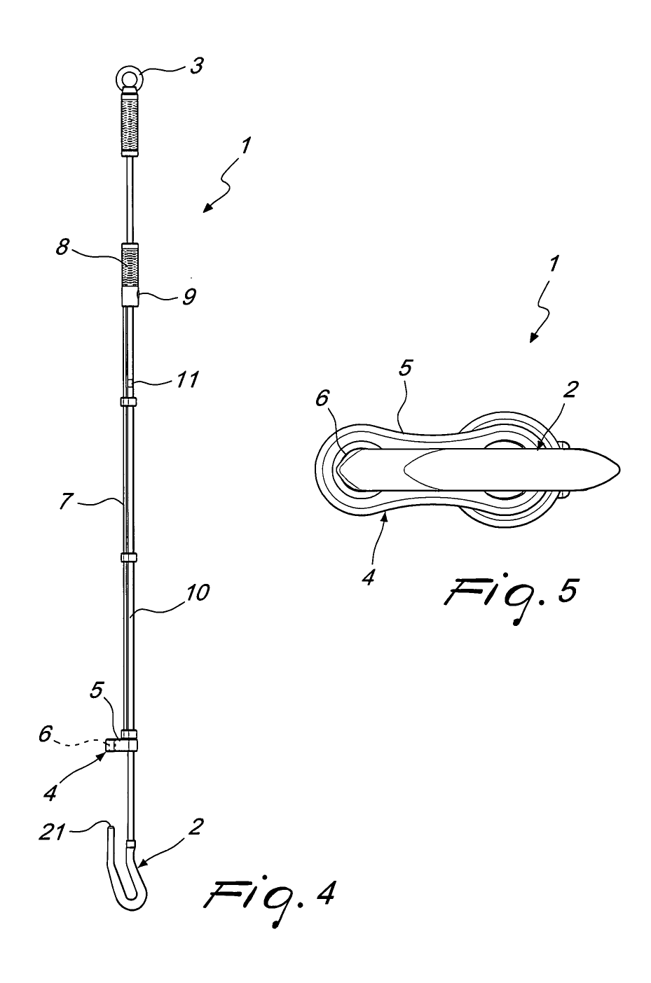

FIG. 5 is a bottom view of the device.

With reference to the figures, the device according to the invention, generally designated by the reference number 1, comprises a rod member 10 provided with a hook-shaped end 2 adapted to be fastened to a mooring ring, not shown in the figures.

The hook-shaped end 2 has a hook tip 21.

At the opposite end with respect to the hook, the rod ends with a ring 3 for is fastening to the boat.

A sliding member 4 is arranged on the rod 1 and is provided with a tab 5 in which there is a hole 6.

A second rod 7, fitted parallel to the rod 10, has one end connected to the sliding member 4 and the other hand connected to a handle 8.

The handle 8 is slidingly associated with the first rod 10 and, by moving the handle 8 along the first rod 10, the sliding member 4 is made to move between an open configuration, wherein the sliding member 4 is at a distance from the hook tip 21, and a closed configuration wherein the hook tip 21 is inserted into the hole 6 of the tab 5 of the sliding member 4.

The handle 8 is provided with a locking device adapted to lock the handle, and therefore the sliding member, in the closed configuration.

The locking device is constituted by an interference member adapted to engage a dent 11, or similar, provided in the first rod 10. The interference member may be disengaged from the dent 11 by a push button 9 provided on the handle, when the sliding member 4 has to be moved from the closed configuration to the open configuration.

The locking device may also lock the handle 8 in the open position by engaging a dent 12 provided on the first rod 10 in an upper position, closer to the ring 3.

When the device is in the open configuration, visible in FIG. 4, the hook tip 21 is not inserted in the hole 6 of the sliding member and it is therefore possible to insert the hook-shaped end 2 in a mooring ring.

FIGS. 1-3 show the sliding member 4 in the closed configuration whereby the hook tip 21 is inserted in the hole 6.

When the device is in the closed configuration, the handle locking device prevents the accidental escape of the hook tip 21 from the hole 6 of the tab 5 of the sliding member 4.

The mooring manoeuver occurs as follows: first the hook-shaped end of the device is hooked to a mooring ring and immediately after the ring is hooked, the sliding member 4 is made to close the hook-shaped end by sliding the handle 8 along the first rod 10. The locking device is automatically activated, for example by spring action, thus preventing the unwanted opening of the hook.

The boat thus remains moored to the buoy by means of the rod 10, which therefore acts both as a boat-hook and as a mooring rope or a component of the mooring rope.

The unmooring manoeuver is performed in the following manner: by acting on the push-button 9, the handle 8 may be operated to make the sliding member slide along the first rod 10 away form the hook tip 21, so that the hook tip 21 is disengaged from the hole of the sliding member. The hook is then disengaged from the mooring ring and the boat is free to leave.

The device according to the invention is efficient, functional and economical and make the mooring and unmooring manoeuvers considerably easier and safer.

This application claims the priority of Italian Utility Model Application No. MI2009U000156, filed on May 13, 2009, the subject matter of which is incorporated herein by reference.

1. A mooring device for boats, comprising a first rod having a hook-shaped end adapted to hook a mooring ring, a fastening ring provided at the opposite end with respect to said hook-shaped end, a sliding member adapted to slide along said first rod between at least two positions, a closed position where said sliding member closes said hook-shaped end, and an open position where said sliding member is away from said hook-shaped end; said sliding member is remotely operated by means of a handle sliding on said first rod and associated with said sliding member by means of a second rod.

2. The mooring device according to claim 1, wherein said hook-shaped end has a hook tip, said sliding member has a tab provided with a hole; said second rod is fitted parallel to said first rod and has one end connected to said sliding member and another end connected to said handle; said handle is slidingly associated with said first rod and, by moving said handle along said first rod, said slinging member is made to move between said open position, wherein said sliding member is at a distance from said hook tip, and said closed position wherein said hook tip is inserted into said hole of said tab said sliding member.

3. The mooring device according to claim 1, further comprising a locking device adapted to lock said sliding member in said closed position.

4. The mooring device according to claim 3, wherein said locking device is provided in said handle and is released by means of a push button provided in said handle.

5. The mooring device according to claim 4, wherein said locking device is constituted by an interference member adapted to engage a dent, or similar, provided in said first rod, said interference member may be disengaged from said dent by said push button provided on said handle, when said sliding member has to be moved from said closed position to said open position.
